(19) United States
(12) Patent Application Publication
(10) Pub. No.: US 2006/0109505 A1
(43) Pub. Date: May 25, 2006

(54) Method for upgrading firmware of image forming device using mobile terminal

(75) Inventors: Jun-hyung Ha, Yongin-si (KR); Sang-hyup Lee, Suwon-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 11/282,629

(22) Filed: Nov. 21, 2005

(30) Foreign Application Priority Data
Nov. 20, 2004 (KR) 2004-95497

(51) Int. Cl. G06F 3/12

(52) U.S. Cl. 358/1.15

(57) ABSTRACT

A method of upgrading firmware of an image forming device using a mobile terminal, includes connecting a mobile terminal to the image forming device, the mobile terminal having a memory storing therein firmware of the image forming apparatus, transmitting information on the firmware of the memory to the image forming device in response to a firmware upgrade request of the image forming device, comparing the transmitted firmware information from the mobile terminal with the firmware stored at the image forming apparatus, and upgrading the firmware of the image forming device according to the comparison result.

### CROSS-REFERENCE TO RELATED APPLICATION

This application claims benefit under 35 U.S.C. § 119 (a) of Korean Patent Application No. 2004-95497 filed on Nov. 20, 2004, the entire content of which is incorporated herein by reference.

### BACKGROUND OF THE INVENTION

1. Field of the Invention

The present invention relates to a method of upgrading a firmware of an imageforming device. More particularly, the present invention relates to a method of upgrading a firmware to control operations of the image forming apparatus using a mobile terminal.

2. Description of Related Art

Generally, an image forming device such as a copier, a printer, and a facsimile machine applies firmware for controlling hardware, and the firmware is stored to a Flash ROM or an EEPROM. The firmware is typically continuously upgraded for improving the capability of the image forming device.

An image forming device with a conventional network function needs to access a firmware supply server via a network and download a newer version of firmware to upgrade the firmware.

Meanwhile, a local image forming device without network function needs to use a host computer with a network function, or use a mobile storage medium with a stored firmware to upgrade the firmware.

However, when upgrading the firmware of the image forming device using the host computer, it is only possible to upgrade the firmware in a limited place where the host computer is installed. When upgrading the firmware with the mobile storage medium, it is difficult to real-time check the newer firmware.

### BRIEF SUMMARY

An aspect of the present invention is to provide a method of upgrading a firmware of an image forming device using a mobile terminal to real-time download a newer version of firmware regardless of whether an image forming device is connected to a network or not.

According to an aspect of the present invention, there is provided a method of upgrading firmware of an image forming device using a mobile terminal, including: connecting a mobile terminal to the image forming device, the mobile terminal having a memory storing therein the firmware of the image forming apparatus; transmitting information on the firmware of the memory to the image forming device in response to a firmware upgrade request of the image forming device; comparing the transmitted firmware information from the mobile terminal with the firmware stored at the image forming apparatus; and upgrading the firmware of the image forming device according to the comparison result.

The method may further include requesting the mobile terminal for a download of the firmware stored at the memory if the firmware stored at the memory is a newer version than that stored at the image forming device as a result of the comparison.

The method may further include terminating the upgrade of the firmware if the firmware stored at the memory is not newer than that stored at the image forming device as a result of the comparison.

The image forming device and the mobile terminal may be connected to each other via one of wired and/or wireless interfaces.

According to another aspect of the present invention, there is provided a method of upgrading firmware of an image forming device using a mobile terminal, including: connecting the mobile terminal to the image forming device, the mobile terminal having a memory storing therein the firmware of the image forming device; the mobile terminal requesting information on the firmware stored in the image forming device to the image forming device in response to a firmware upgrade request of the image forming device; comparing the firmware information received from the image forming device with the firmware information stored at the memory; and upgrading the firmware of the image forming device according to the comparison result.

The method may further include downloading the firmware stored at the memory to the image forming device if the firmware stored at the memory is a newer version than that stored at the image forming device and, wherein, in the upgrading, the firmware of the image forming device is upgraded to the firmware downloaded from the mobile terminal.

The method may further include inquiring whether to download a newer version of the firmware if the firmware stored at the memory is a newer version than that stored at the image forming device, wherein, in the downloading, the firmware stored at the memory is downloaded to the image forming device when there is a request to download the newer version of the firmware.

The signal inquiring as to whether to download the firmware may be output via at least one of a display part of the mobile terminal and a display unit of the image forming device.

According to another aspect of the present invention, there is provided a method of upgrading firmware of an image forming device using a mobile terminal, comprising: connecting the mobile terminal to upgrade the firmware of the image forming device; the mobile terminal accessing a firmware server supplying the firmware relevant to the image forming device; downloading a newer version of firmware relevant to the image forming device from the firmware server, and downloading the newer version of the firmware downloaded from the firmware server to the image forming device.

The method may further include upgrading the firmware of the image forming device to the firmware downloaded from the mobile terminal.

The method may further include requesting the firmware information of the image forming device to upgrade the firmware of the image forming device; and comparing the firmware information received from the image forming device with the firmware information stored at the memory of the mobile terminal, and wherein, in the accessing, the firmware server is accessed if the firmware stored at the image forming device is a newer version than that stored at the memory.

The method may further include receiving a request signal on an authentication information from the firmware server; and transmitting the authentication information to the firmware server in response to the request signal, wherein the firmware server, upon confirming the authentication, searches a newer version of firmware relevant to the image forming device and downloads the searched firmware to the mobile terminal.

The method may further include upgrading the firmware stored at the memory to the newer version of firmware prior to transmitting to the image forming device the newer version of firmware downloaded from the firmware server.

The firmware upgrade request of the image forming device may be input through one of a key operation unit of the image forming device and a key operation part of the mobile terminal.

The image forming device and the mobile terminal may be connected to each other via one of wired and wireless interfaces.

The mobile terminal may be communicated with the firmware server in a wireless communication.

Additional and/or other aspects and advantages of the present invention will be set forth in part in the description which follows and, in part, will be obvious from the description, or may be learned by practice of the invention.

### BRIEF DESCRIPTION OF THE DRAWINGS

The above and/or other aspects and advantages of the present invention will become apparent and more readily appreciated from the following detailed description, taken in conjunction with the accompanying drawings of which:

FIG. 1 is a schematic view of an upgrade system according to a first embodiment of the present invention;

FIG. 2 is a block diagram of the printer of FIG. 1;

FIG. 3 is a block diagram of the mobile terminal of FIG. 1;

FIG. 4 is an example of a message sequence for explaining a firmware upgrade method according to the first embodiment of the present invention;

FIG. 5 is another example of a message sequence for explaining a firmware upgrade method according to the first embodiment of the present invention;

FIG. 6 is a schematic view of an upgrade system according to a second embodiment of the present invention;

FIG. 7 is an example of a message sequence for explaining a firmware upgrade method according to the second embodiment of the present invention; and

FIG. 8 is another example of a message sequence for explaining a firmware upgrade method according to the second embodiment of the invention.

### DETAILED DESCRIPTION OF EMBODIMENTS

Reference will now be made in detail to embodiments of the present invention, examples of which are illustrated in the accompanying drawings, wherein like reference numerals refer to the like elements throughout. The embodiments are described below in order to explain the present invention by referring to the figures.

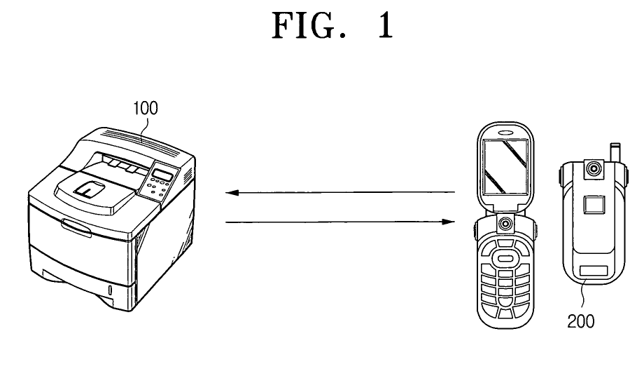

FIG. 1 is a schematic view of an upgrade system according to a first embodiment of the present invention.

Referring to FIG. 1, an upgrade system according to the present embodiment comprises a printer 100, which is an example of an image forming device, and a mobile terminal 200, and the printer 100 and the mobile terminal 200 can be connected to each other via one of a wired and a wireless interface such as a universal serial bus (USB), infrared data association (IrDA), and Bluetooth.

The mobile terminal 200 according to the present embodiment comprises a memory storing a firmware relevant to the printer 100, and examples thereof may include a PDA (Personal Digital Assistant), a cellular phone, and a PCS (Personal Communication Services).

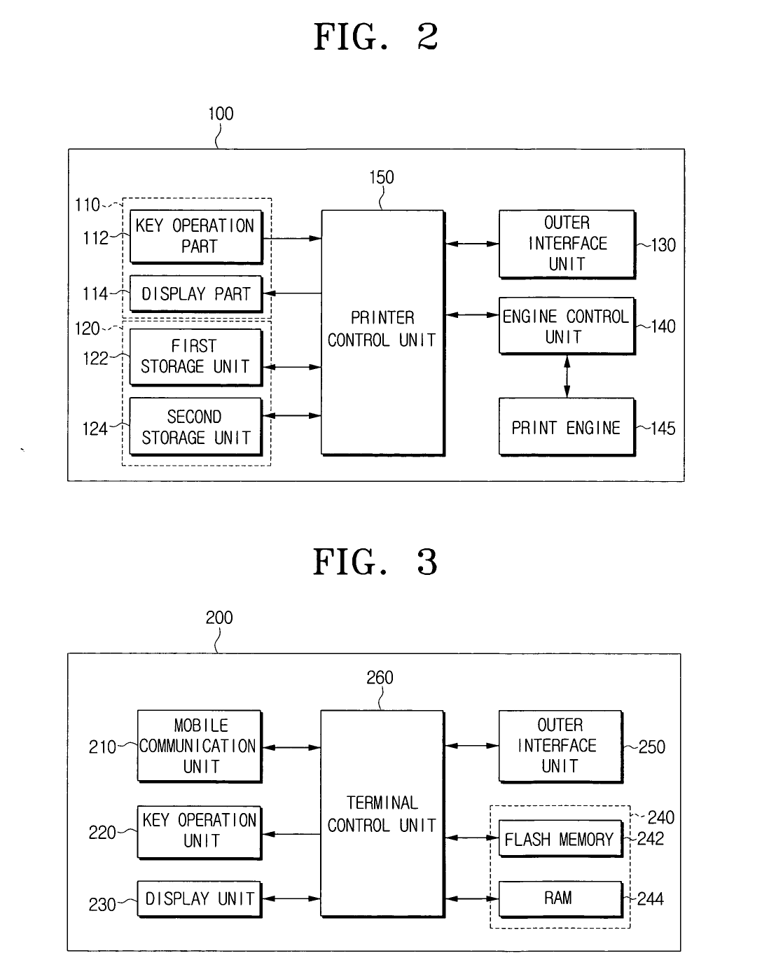

FIG. 2 is a schematic block diagram of the printer 100 of FIG. 1

The printer 100 according to the present embodiment comprises an operation panel 110, a memory unit 120, an outer interface unit 130, an engine control unit 140, and a printer control unit 150.

The operation panel 110 comprises a key operation part 112 and a display part 114.

The key operation part 112 comprises a plurality of keys for selecting and setting functions of printer 100, and outputs a key operation signal according to the key input to the printer control unit 150. A user operates keys on the key operation part 112 to input an upgrade request signal for firmware stored to the memory unit 120.

The display part 114 is generally implemented as a LCD (Liquid Crystal Display), and displays an operation status of the printer 200 according to control of the printer control unit 150.

The memory unit 120 comprises a first storage unit 122 and a second storage unit 124.

The first storage unit 122 is a nonvolatile memory element, and stores various control programs (“firmware” hereinafter) necessary for implementing functions of the printer 100. The firmware stored to the first storage unit 122 according to the present embodiment can be upgraded to a newer version of firmware downloaded from the mobile terminal 200.

The second storage unit 124 may be a volatile memory element, and temporarily stores various data generated during operation of the printer control unit 150. For example, the firmware downloaded from the mobile terminal 200 is stored to the second storage unit 124 according to the present embodiment.

The outer interface unit 130 provides various interfaces capable of connecting to the mobile terminal 200. For example, the outer interface unit 130 according to the present embodiment provides one of a USB interface, an IrDA interface, and a Bluetooth interface.

The engine control unit 140 controls a print engine 145 to print data according to the control of the printer control unit 150. The print engine 145 prints data according to the control of the engine control unit 140.

The printer control unit 150 controls general operations of the printer 100 according to programs stored at the first storage unit 122. The printer control unit 150 temporarily stores the firmware downloaded from the mobile terminal 200 to the second storage unit 124, and upgrades the firmware stored at the first storage unit 122 to the firmware stored at the second storage unit 124.

FIG. 3 is a block diagram of the mobile terminal 200 of FIG. 1.

Referring to FIG. 3, the mobile terminal 200 comprises a mobile communication unit 210, a key operation unit 220, a display unit 230, a memory unit 240, an outer interface unit 250, and a terminal control unit 260.

The mobile communication unit 210 provides a communication interface with an outer terminal.

The key operation unit 220 comprises number keys for dialing, and various function keys, and transmits a key operation signal according to the key input to the terminal control unit 260.

The display unit 230 is generally implemented as the LCD, and displays operation status of the mobile terminal 200 according to the control of the terminal control unit 260.

The memory unit 240 comprises a flash memory 242 for storing a control program necessary to function the mobile terminal 200, and a RAM 244 temporarily storing data generated during operation of the control unit 260. A certain version of firmware relevant to the printer 100 is stored to the flash memory 240 according to the present embodiment.

The outer interface unit 250 provides various interfaces capable of connecting to the printer 100. For example, the outer interface unit 250 provides at least one of the USB interface, the IrDA interface, and the Bluetooth interface.

The terminal control unit 260 controls general operations of the mobile terminal 200 according to control program stored at the flash memory 240. The terminal control unit 260 according to the present embodiment controls the outer interface unit 250 to transmit the firmware stored at the flash memory 242 to the printer 100 in response to firmware download request signal received from the printer 100 via the key operation unit 220 or the outer interface unit 250.

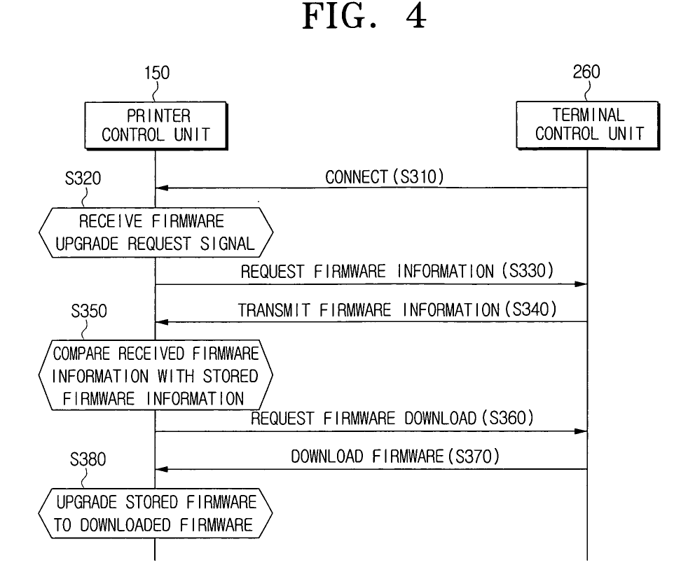

FIG. 4 is an example of a message sequence for explaining a firmware upgrade method according to the first embodiment. FIG. 4 is a view of an example in case that the printer 100 operates as a host in the upgrade system of FIG. 1.

Referring to FIG. 4, the mobile terminal 200 is connected to the printer 100 (S310). When an upgrade request signal for firmware stored at the first storage unit 122 is received via the key operation part 112 of the printer 100 (S320), the printer control unit 150 transmits the information request signal for the firmware stored at the mobile terminal 200 to the mobile terminal 200 (S330). At this time, the printer control unit 150 transmits its model name to the mobile terminal 200.

The terminal control unit 260, on receiving the firmware information request signal from the printer 100, searches if the flash memory 240 has firmware corresponding to the model name received from the printer 100. If so, the terminal control unit 260 reads out the information on the firmware to transmit it to the printer 100 (S340).

If the information on the firmware is received from the mobile terminal 200, the printer control unit 150 compares the received firmware information to the information stored at the first storage unit 122 (S350). As a result of operation of S350, if it is determined that the version of the firmware stored at the mobile terminal 200 is newer than that stored at the first storage unit 122, the printer control unit 150 transmits the firmware download request signal to the mobile terminal 200 (S360). However, as a result of the operation of S350, if it is determined that the version of the firmware stored at the mobile terminal 200 is not newer than that stored at the first storage unit 122, the printer control unit 150 terminates operations of the firmware upgrade.

The terminal control unit 260, on receiving the firmware download request signal from the printer 100, downloads the firmware stored at the flash memory 240 to the printer 100 (S370).

The printer control unit 150 downloaded with the firmware from the mobile terminal 200 upgrades the firmware stored at the first storage unit 122 to the firmware downloaded with the firmware stored at the first storage unit 122 (S380).

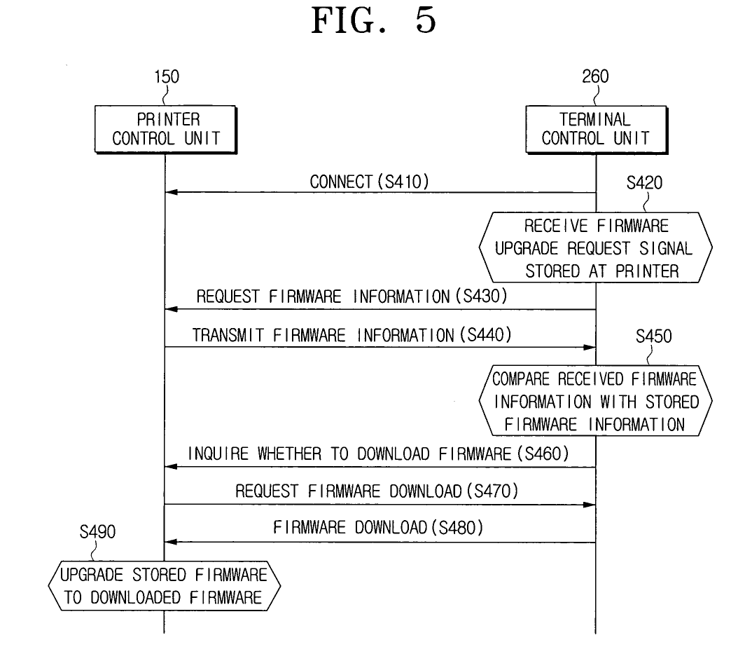

FIG. 5 is another example of a message sequence for explaining a firmware upgrade method according to the first embodiment. FIG. 5 is a view of an example in case that the mobile terminal 200 operates as a host in the upgrade system of FIG. 1.

Referring to FIG. 5, the mobile terminal 200 is connected to the printer 100 (S410). If the upgrade request signal is received for the firmware stored at the printer 100 from the key operation unit 220 of the mobile terminal 200 (S420), the terminal control unit 260 requests the firmware information stored at the printer 100 (S430).

The printer control unit 150, on receiving the firmware request signal from the mobile terminal 200, transmits the firmware information such as a printer model name, a firmware version information stored at the first storage unit 122 to the mobile terminal 200 (S440).

The terminal control unit 260, on receiving the firmware information from the printer 100, compares the received firmware information with the firmware information stored at the flash memory 240 (S450). As a result of the operation of S450, if it is determined that the firmware version stored at the flash memory 240 is newer than the firmware version stored at the printer 100, the terminal control unit 260 transmits to the printer 100 an inquiry signal as to whether the firmware is to be downloaded (S460). Conversely, if it is determined that the firmware version stored at the printer 100 is newer than the firmware version stored at the mobile terminal 200, the terminal control unit 260 terminates upgrade operations of the firmware stored at the printer 100.

The printer control unit 150, which receives the inquiry signal as to whether to download the firmware from the mobile terminal 200, generates a message for a user to select whether to download the firmware and displays the message via the display part 114. In response to the message, when the download request signal is received from the key operation part 112, the printer control unit 150 transmits to the mobile terminal 200 the firmware download request signal received from the key operation unit 112.

The terminal control unit 260, which receives the firmware download request signal from the printer 100, downloads the firmware stored at the flash memory 240 to the printer 100 (S480). The printer control unit 150 downloaded with the firmware from the mobile terminal 200 upgrades the firmware stored at the first storage unit 122 to the downloaded firmware (S490).

In the operation of S460, the inquiry signal as to whether to download the firmware is transmitted to the printer 100, however, this should not be considered as limiting. The inquiry signal may be displayed on the display unit 230 of the mobile terminal 200, and a user may select whether to download the firmware via the key operation unit 220 of the mobile terminal 200.

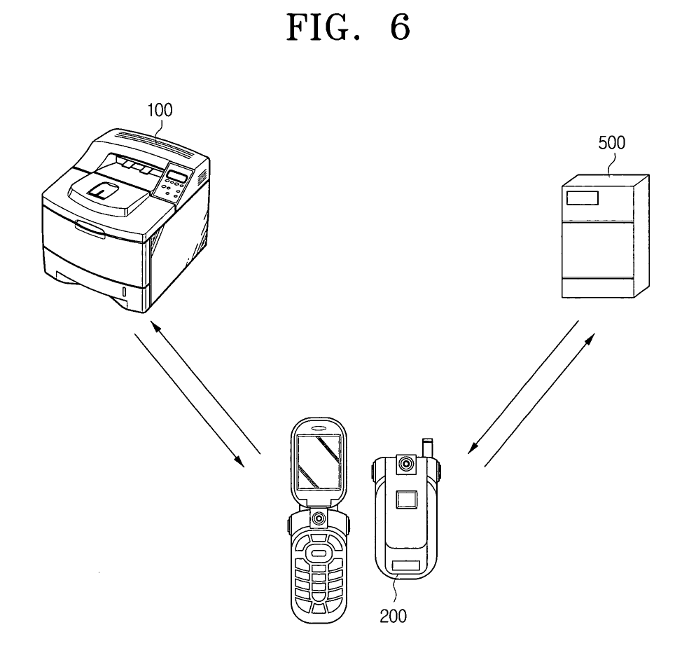

FIG. 6 is a schematic view of the upgrade system according to a second embodiment of the present invention.

Referring to FIG. 6, the upgrade system according to the present embodiment comprises the printer 100, the mobile terminal 200, and a firmware server 500. Between the printer 100 and the mobile terminal 200, data are communicated via a wired or wireless interface module such as USB, IrDA, Bluetooth, and between the mobile terminal 200 and the firmware server 500, data are communicated via a mobile communication module such as CDMA (Code Division Multiple Access) and GSM (Global System for Mobile). The printer 100 and the mobile terminal 200 according to the present embodiment need identical communication protocol to data-communicate to each other.

The firmware server 500 supplies firmware relevant to the printer 100, and has DB (Data Base, not shown) in which a certain version of firmware is stored. The constructions of the printer 100 and the mobile terminal 200 according to the present embodiment are substantially the same as those of FIGS. 2 and 3, and therefore, the drawings are omitted.

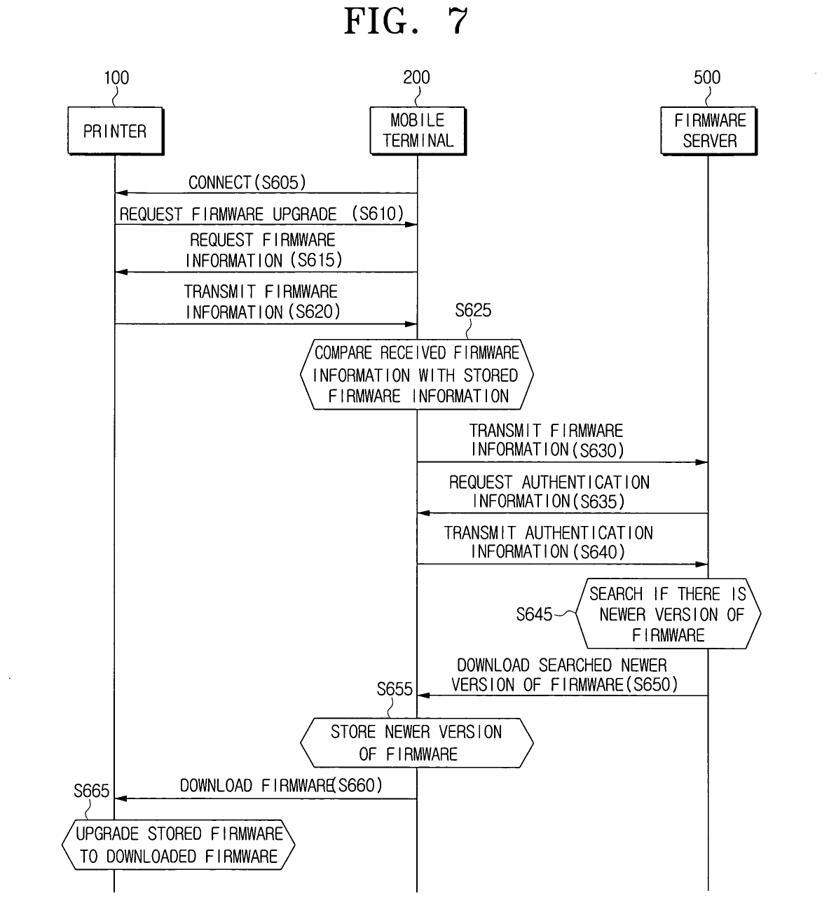

FIG. 7 is an example of a message sequence for explaining the firmware upgrade method according to the second embodiment.

Referring to FIG. 7, the mobile terminal 200 is connected to the printer 100 (S605). When the firmware upgrade request signal of the printer 100 is received from the printer 100 (S610), the mobile terminal 200 requests the firmware information stored at the printer 100 (S615).

The printer 100 receiving the firmware information request signal from the mobile terminal 200 reads out the stored firmware information to transmit the information to the mobile terminal 200 (S620).

The terminal control unit 260 receiving the firmware information from the printer 100 compares the received firmware information with the pre-stored firmware information (S625). As a result of the operation of S625, if it is determined that the firmware version stored at the printer 100 is newer than the pre-stored firmware version, the mobile terminal 200 transmits to the firmware server 500 the firmware information stored at the printer 100 (S630). Conversely, if it is determined that the pre-stored firmware version is newer than the firmware version stored at the printer 100, the operations are substantially the same as the operation of S460 and the next operations of FIG. 5, and therefore, the detailed description and drawings are omitted.

The firmware server 500 receives the firmware information transmitted from the mobile terminal 200 and requests the mobile terminal 200 for authentication information (S635). The mobile terminal 200 receives the request signal for the authentication information from the firmware server 500 and transmits to the mobile terminal 200 the authentication information such as ID and password input by a user (S640).

When the authentication is confirmed, the firmware server 500 searches to determine if there is newer version of firmware in the DB than that from the mobile terminal 200 (S645). If so, the firmware server 500 downloads the searched new version of firmware to the mobile terminal 200 (S650). If not, the firmware server 500 transmits to the mobile terminal 200 the information, notifying that there is no newer version of firmware in the DB than that from the mobile terminal 200. At this time, the mobile terminal 200 terminates the firmware upgrading of the printer 100.

The mobile terminal 200 with the newer version of firmware downloaded from the firmware server 500 upgrades the pre-stored firmware to the downloaded newer version of firmware (S655). The mobile terminal 200 downloads the pre-stored newer version of firmware to the printer 100 (S660). The operation of inquiring as to whether to download the firmware prior to the operation of S660 is omitted since the firmware upgrade request signal is received from the printer 100 in the operation of S610.

The printer 100 with the newer version of firmware downloaded from the mobile terminal 200 upgrades the pre-stored firmware to the downloaded newer version of firmware (S665).

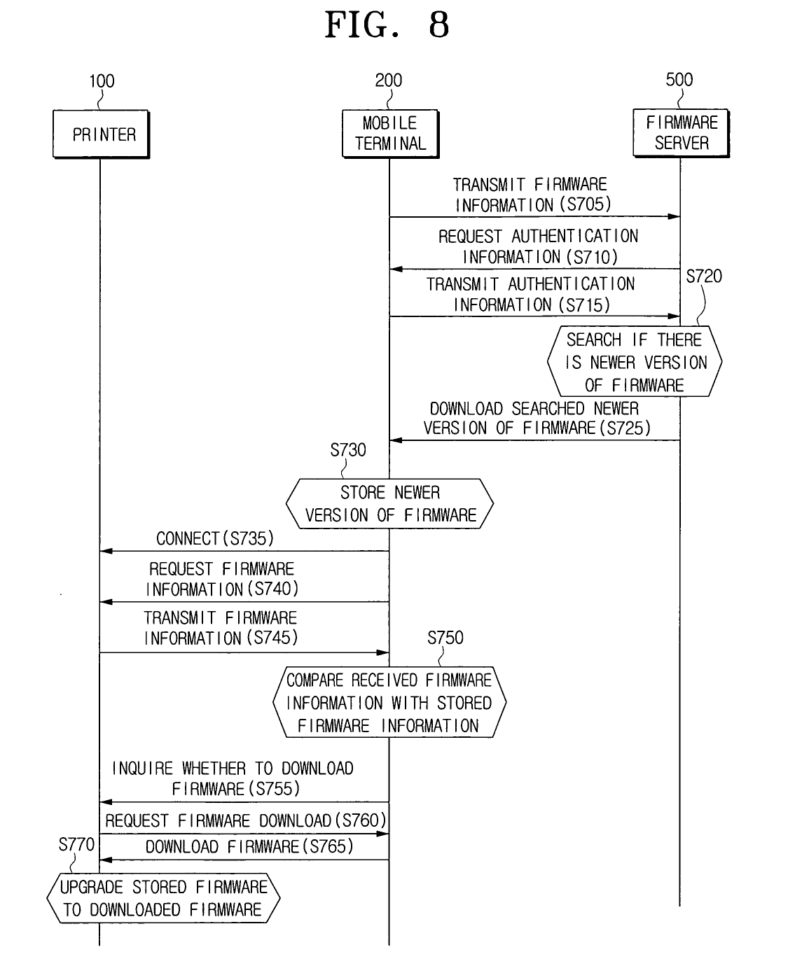

FIG. 8 is another example of a message sequence for explaining the firmware upgrading method according to the second embodiment.

Referring to FIG. 8, the mobile terminal 200 receives the firmware upgrade request signal from a user and accesses the firmware server 500 to transmit the firmware information such as printer model name and firmware version information (S705). The firmware server 500 with the firmware information received from the mobile terminal 200 requests the mobile terminal 200 for the authentication information (S710).

The mobile terminal 200, which receives the authentication request signal from the firmware server 500, transmits the authentication information such as ID and password to the firmware server 500 (S715).

Upon confirming the authentication, the firmware server 500 searches to determine if the DB has a newer version of firmware corresponding to the firmware information from the mobile terminal 200 (S720). If so, the firmware server 500 downloads the searched newer version of firmware to the mobile terminal 200 (S725). If not, the firmware server 500 transmits to the mobile terminal 200 the signal informing that there is no relevant firmware.

The mobile terminal 200 with the newer firmware downloaded from the firmware server 500 upgrades the pre-stored firmware to the downloaded newer version of firmware (S730).

When the firmware stored at the printer 100 is desired to be upgraded to the newer version of firmware stored at the mobile terminal 200, a user connects the mobile terminal 200 to the printer 100 (S735). The operations of operations of S740 to S770 are substantially the same as the operations of S430 to S490 of FIG. 5, and therefore, the detailed descriptions thereof will be omitted.

In the above-described embodiments of the present invention, the printer 100 is explained as an example of the image forming device, however, this should not be considered as limiting. The present invention may be applied to, for example, a facsimile machine, a copier, and a multi-functional apparatus.

If the above-described embodiments of the present invention are applied, it is possible to real-time upgrade the firmware of the image forming device even when the image forming device is not connected to network, because it is easy to download a newer version of firmware of an image forming device using a mobile terminal. Accordingly, it is convenient to a user.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

What is claimed is:

1. A method of upgrading firmware of an image forming device using a mobile terminal, comprising:
connecting a mobile terminal to the image forming device, the mobile terminal having a memory storing therein firmware of the image forming apparatus;
transmitting information on the firmware of the memory to the image forming device in response to a firmware upgrade request of the image forming device;
comparing the transmitted firmware information from the mobile terminal with the firmware stored at the image forming apparatus; and
upgrading the firmware of the image forming device according to the comparison result.

2. The method as claimed in claim 1, further comprising requesting the mobile terminal for a download of the firmware stored at the memory when the firmware stored at the memory is a newer version than that stored at the image forming device as a result of the comparison.

3. The method as claimed in claim 1, further comprising terminating the upgrade of the firmware when the firmware stored at the memory is not newer than that stored at the image forming device as a result of the comparison.

4. The method as claimed in claim 1, wherein the image forming device and the mobile terminal are connected to each other via a wired interface or a wireless interface.

5. A method of upgrading firmware of an image forming device using a mobile terminal, comprising:
connecting the mobile terminal to the image forming device, the mobile terminal having a memory storing therein firmware of the image forming device;
requesting, via the mobile terminal, information on the firmware stored in the image forming device to the image forming device in response to a firmware upgrade request of the image forming device;
comparing the firmware information received from the image forming device with the firmware information stored at the memory; and
upgrading the firmware of the image forming device according to the comparison result.

6. The method as claimed in claim 5, further comprising downloading the firmware stored at the memory to the image forming device when the firmware stored at the memory is a newer version than that stored at the image forming device, wherein, in the upgrading, the firmware of the image forming device is upgraded to the firmware downloaded from the mobile terminal.

7. The method as claimed in claim 5, further comprising inquiring whether to download a newer version of the firmware when the firmware stored at the memory is a newer version than that stored at the image forming device,
wherein, in the downloading, the firmware stored at the memory is downloaded to the image forming device when there is a request to download the newer version of the firmware.

8. The method as claimed in claim 7, wherein the signal inquiring as to whether to download the firmware is output via at least one of a display part of the mobile terminal and a display unit of the image forming device.

9. The method as claimed in claim 5, wherein the image forming device and the mobile terminal are connected to each other via a wired interface or a wireless interface.

10. A method of upgrading firmware of an image forming device using a mobile terminal, comprising:
connecting the mobile terminal to upgrade the firmware of the image forming device;
accessing, via the mobile terminal, a firmware server supplying the firmware relevant to the image forming device;
downloading a newer version of firmware relevant to the image forming device from the firmware server; and
downloading the newer version of the firmware downloaded from the firmware server to the image forming device.

11. The method as claimed in claim 10, further comprising upgrading the firmware of the image forming device to the firmware downloaded from the mobile terminal.

12. The method as claimed in claim 10, further comprising:
requesting the firmware information of the image forming device to upgrade the firmware of the image forming device; and
comparing the firmware information received from the image forming device with the firmware information stored at the memory of the mobile terminal,
wherein, in the accessing, the firmware server is accessed when the firmware stored at the image forming device is a newer version than that stored at the memory.

13. The method as claimed in claim 12, further comprising:
receiving a request signal for authentication information from the firmware server; and
transmitting the authentication information to the firmware server in response to the request signal,
wherein the firmware server, upon confirming the authentication, searches a newer version of firmware relevant to the image forming device and downloads the searched firmware to the mobile terminal.

14. The method as claimed in claim 10, further comprising upgrading the firmware stored at the memory to the newer version of firmware prior to transmitting to the image forming device the newer version of firmware downloaded from the firmware server.

15. The method as claimed in claim 10, wherein the firmware upgrade request of the image forming device is input through one of a key operation unit of the image forming device and a key operation part of the mobile terminal.

16. The method as claimed in claim 10, wherein the image forming device and the mobile terminal are connected to each other via a wired interface or a wireless interface.

17. The method as claimed in claim 9, wherein the mobile terminal is communicated with the firmware server in a wireless communication.

18. The method of claim 1, wherein the image forming device is a facsimile apparatus, a photocopier, or a multi-functional apparatus.

19. The method of claim 5, wherein the image forming device is a facsimile apparatus, a photocopier, or a multi-functional apparatus.

20. The method of claim 10, wherein the image forming device is a facsimile apparatus, a photocopier, or a multi-functional apparatus.
